(19) United States
(12) Patent Application Publication
(10) Pub. No.: US 2003/0052063 A1
(43) Pub. Date: Mar. 20, 2003

(54) Decontamination method and apparatus

(76) Inventors: Motoaki Sakashita, Hitachi (JP); Kazumi Anazawa, Hitachi (JP); Ichirou Kataoka, Hitachi (JP)

Correspondence Address: MATTINGLY, STANGER & MALUR, P.C., 1800 Diagonal Road, Suite 370, Alexandria, VA, 22314, US

(21) Appl. No.: 10/097,402

(22) Filed: Mar. 15, 2002

(30) Foreign Application Priority Data
Mar. 30, 2001 (JP) 2001-098277

(51) Int. Cl. C02F 1/72

(52) U.S. Cl. 210/758

(57) ABSTRACT

A chemical decontamination apparatus an oxidizing solution reservoir for storing oxidizing agent decontamination agent of a decontamination tank subsequent to oxidizing decontamination, a reducing solution reservoir for storing reducing agent decontamination agent of the aforementioned decontamination tank subsequent to reducing agent decontamination, and a transfer pump for mutual transfer of decontamination agent between the aforementioned decontamination tank and reservoir; and is designed to permit repeated use of decontamination agent.

### BACKGROUND OF THE INVENTION

1. Field of the Invention

The present invention relates to RI facilities or nuclear related facilities, particularly to the method and apparatus for chemical removal of radioactive substances from the surfaces of a great number of metallic members contaminated by radioactive substances.

2. Prior Art

Japanese Application Patent Laid-Open Publication No. Hei 07-253496 is disclosed as a first prior art of chemical decontamination for metallic waste. FIG. 5 illustrates the details of this disclosure. FIG. 6 shows the configuration of a prior art chemical decontamination apparatus. The chemical decontamination method according to prior art configuration will be described with reference to these Figures:

FIG. 5 shows that, for the object to be decontaminated placed in a decontamination tank, the operation of returning decontamination agent in the decontamination tank to the reservoir is performed by repeating the start or stop of the pump, switching between the decontamination agent feed line and circulating line or supply and stop of air, nitrogen and inactive gas at predetermined intervals, thereby preventing decontamination agent concentration from being reduced.

FIG. 5 represents a chemical decontamination apparatus provided with a decontamination tank 2 and a reservoir 3 for storing chemical decontamination agent. In this configuration, the rate of dissolution is reduced, hence, radiation level are claimed to be reduced in a shorter time by repeating a step of solid/liquid separation of transferring decontamination agent 54 from the decontamination tank 2 to the reservoir 3 to separate between the decontamination agent and object to be decontaminated 1, and a step of solid/liquid contact by transferring it from the reservoir 3 to the decontamination tank 2 to contact between decontamination agent and object to decontaminated 1. Numeral 1 in FIG. 5 denotes an object to be decontaminated, 12 a pump, 55 a feed line, 57 a feed valve, 58 a circulating valve, 59 a drain valve, 56 a overflow line and 9 a heater.

FIG. 6 is a drawing representing the configuration of another chemical decontamination apparatus as a second prior art. In this arrangement, an object to be decontaminated is put in a decontamination tank 2. Liquid in the chemical decontamination apparatus is circulated by pump 6 and the temperature is raised by heater 9 from the chemical inlet 13. Oxidizing agent is placed from the chemical agent inlet 13 of a chemical loader to turn the liquid in the decontamination apparatus into oxidizing agent. This state is held for several hours to dissolve chromium oxide contained in the oxide film of the object to be decontaminated.

After that, reducing agent is input from the chemical inlet 13 in oxidizing agent to dissolve oxidizing agent, and, at the same time, the liquid in the chemical decontamination apparatus is turned into reducing agent. This state is held for about ten hours, thereby dissolving the major component of oxide film of the object to be decontaminated such as iron oxide. In this case, reducing agent is fed to a cation resin tower 8 to the remove metal ion dissolved by reducing agent and metal ion generated by decomposition of, oxidizing agent.

After that, decomposing chemical is poured from a decomposing chemical injection apparatus 11, and reducing agent is fed to a reducing agent decomposer 10 (with valves V18 and V19 open), thereby decomposing reducing agent. Upon decomposition of reducing agent, the reagent is fed to mixed bed resin tower 7 (valves V14 and V15) to clean up the object to be decontaminated. Assuming the aforementioned operation steps of chemical decontamination as one cycle, operations are repeated several cycles, depending on the degree of contamination of the object to be decontaminated 1, and chemical decontamination terminates. Reference symbols V1, V5 to V10, V14 to V19 and V27 to V30 denote control valves to be opened or closed as required.

For example, assume that there are four objects to be decontaminated, and two hours are assigned for temperature increase, three hours for oxidizing decontamination, one hour for decomposition of oxidizing agent, six hours for reducing decontamination, nine hours for decomposition of reducing agent, and six hours for cleaning. Table 1 shows an example of the chemical decontamination when two cycles of operation are performed for each object to be decontaminated under these conditions.

TABLE 1

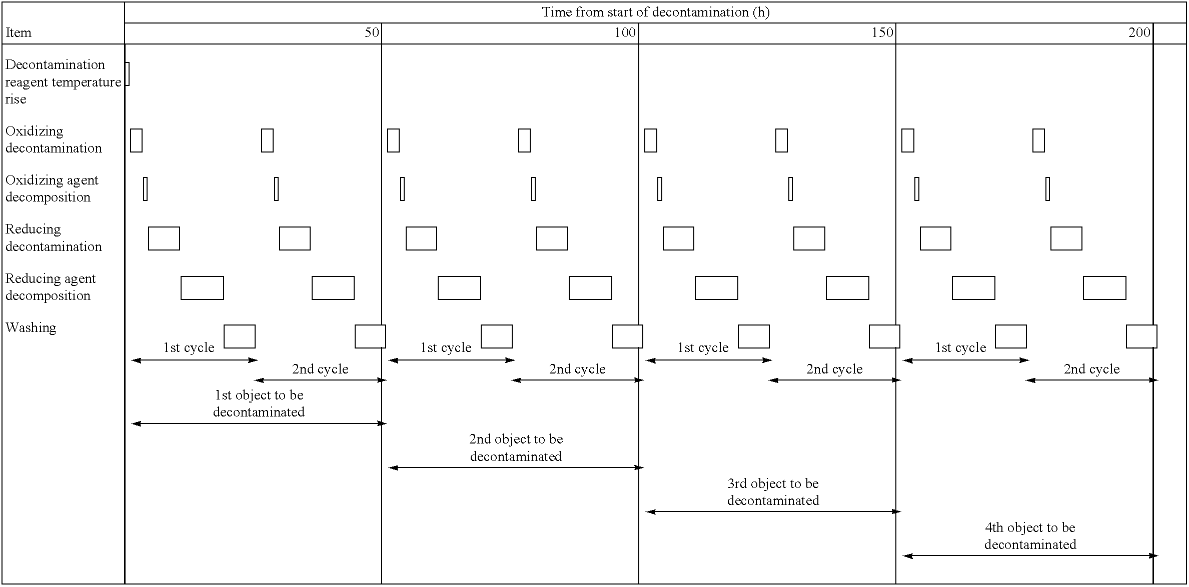

As illustrated in Table, decontamination of one object requires about 50 hours. Decontamination of the second object or later cannot be started before termination of decontamination of the preceding object, so decontamination of only one object is possible every approximately 50 hours. This means that about 200 hours are required to decontaminate four objects. One way to solve this problem is to increase the size, number or performance of the reducing agent decomposer or to shorten reducing agent decomposition time. However, if the device is increased in the size or number, the installation space will have to be expanded. Furthermore, circulating flow rate will be essential, with the result that equipment cost must be raised. Improvement of the reducing agent decomposer performance will require various tests to be conducted for development, and this will need much development time.

### SUMMARY OF THE INVENTION

(Problems to be Solved by the Invention)

In the aforementioned first prior art, only one reservoir 3 is installed. It fails to show the operation method for chemical decontamination of the objects, separately using two types of decontamination agent—reducing and oxidizing agents. Furthermore, after termination of chemical decontamination, decontamination agent remains on the decontaminated object. So it is difficult to discard the object under this condition, and this requires a further step of removing decontamination agent. This method is not shown in the first prior art. Further, used decontamination agent must be processed by decomposition or other methods which are not disclosed.

In the aforementioned the second prior art, steps of oxidizing decontamination, decomposition of oxidizing agent, reducing decontamination, decomposition of reducing agent and cleaning are required for each cycle. Thus, a long time must be spent on chemical decontamination.

Further, decomposition of oxidizing agent and reducing agent in each cycle requires new chemicals to be used for oxidizing decontamination or reducing decontamination in the next process. This will consume a lot of chemicals. For example, when the amount of oxidizing agent is 3 m³ and 200 ppm of potassium permanganate is used as oxidizing agent, about 0.6 kg of potassium permanganate will be needed for each cycle. Further, if the amount of reducing agent of 3 m³, 2000 ppm of oxalic acid is used as reducing agent, and potassium permanganate in oxidizing agent is decomposed by oxalic acid, then about 7.4 kg of oxalic acid will be necessary for each cycle.

Accordingly, if one object is to be subjected to two cycles of decontamination, decontamination of four objects will require about 4.8 kg of potassium permanganate, and about 59.2 kg of oxalic acid. One way to solve this problem is to reduce chemical concentration, but reduction of chemical concentration will be accompanied by reduced effect of decontamination.

Furthermore, metal ion generated by decomposition of oxidizing agent is absorbed by cation resin, with the result that cation resin load is increased. For example, when the surface area of one object to be decontaminated is 40 m², the amount of oxidizing agent is 3 m³ and 200 ppm of potassium permanganate is used as oxidizing agent, then the amounts of load of potassium ion and manganese ion generated by decomposition of oxidizing agent in cation resin account for about 35% of the total amount of the cation resin load. This requires the amount of cation resin to be increased, and the equipment capacity to be increased.

The object of the present invention is to provide a chemical decontamination method and apparatus which, when a great number of metallic members contaminated by a radioactive substance are to be decontaminated, ensures an efficient removal of radioactive substances from the surface in a shorter period of time and reduces the amount of chemicals to be used and the amount of resin as secondary waste at the same time.

(Means for Solving the Problems)

The present invention intended to achieve the aforementioned object is a chemical decontamination method and apparatus wherein a reducing solution reservoir and an oxidizing solution reservoir are provided to transfer decontamination agent from a decontamination tank to a reducing solution reservoir or oxidizing solution reservoir and to transfer it from the reducing solution reservoir or oxidizing solution reservoir to the decontamination tank, thereby capable of repeating decontamination of the object several times without decomposing the decontamination agent. The following describes specific means:

A chemical decontamination method for decontamination of an object placed in a decontamination tank is characterized by comprising the steps of: adding an oxidizing agent into a circulating path comprising said decontamination tank, a heater, and a circulating pump connected by a set of circulating pipes; performing oxidizing decontamination of said decontamination object using an oxidizing solution filled in said circulating path; transferring said oxidizing solution to an oxidizing solution reservoir subsequent to said oxidizing decontamination; and, if oxidizing decontamination is further carried out, transferring said oxidizing solution in said oxidizing solution reservoir to said circulating path; and performing oxidizing decontamination of said decontamination object using said oxidizing solution filled in said circulating path.

A chemical decontamination method for decontamination of an object placed in a decontamination tank is characterized by comprising the steps of: adding a reducing agent into a circulating path comprising said decontamination tank, a heater, and a circulating pump connected by a set of circulating pipes; performing reducing decontamination of said decontamination object using a reducing solution filled in said circulating path; transferring said reducing solution to a reducing solution reservoir subsequent to said reducing decontamination; and, if reducing decontamination is further carried out, transferring said reducing solution in said reducing solution reservoir to said circulating path; and performing reducing decontamination of said decontamination object using said reducing solution filled in said circulating path.

A chemical decontamination method for decontamination of an object placed in a decontamination tank is characterized by comprising the steps of: filling a first circulating path comprising said decontamination tank, a circulating pump, and a heater connected by a set of circulating pipes with demineralized water; circulating said demineralized water by said circulating pump; heating said demineralized water by said heater; adding an oxidizing agent into said first circulating path when said demineralized water reaches at a pre-determined temperature; performing oxidizing decontamination of said decontamination object by maintaining an oxidizing solution filled in said first circulating path at a pre-determined temperature for a pre-determined time; transferring said oxidizing solution to an oxidizing solution reservoir by a transfer pump subsequent to said oxidizing decontamination, filling a second circulating path comprising said decontamination tank, said circulating pump, said heater, and a cation resin tower connected by a set of circulating pipes with demineralized water; circulating said demineralized water by said circulating pump; heating said demineralized water by said heater; adding a reducing agent into said second circulating path when said demineralized water reaches at a pre-determined temperature; performing reducing decontamination of said decontamination object by maintaining an reducing solution filled in said second circulating path at a pre-determined temperature for a pre-determined time; transferring said reducing solution to a reducing solution reservoir by said transfer pump subsequent to said reducing decontamination; filling a third circulating path comprising said decontamination tank, said circulating pump, said heater, and a mixed bed resin tower connected by a set of circulating pipes with demineralized water; and cleaning up said decontamination object by circulating said demineralized water by said circulating pump.

A chemical decontamination apparatus comprising a decontamination tank, a pump, a heater, a mixed bed resin tower, a cation resin tower, a reducing agent decomposer and decomposing chemical agent adding apparatus, characterized by further comprising: an oxidizing solution reservoir for storing an oxidizing solution used for oxidizing decontamination in said decontamination tank; a reducing solution reservoir for storing a reducing solution used for reducing decontamination in said decontamination tank, and a transfer pump for mutual transfer of decontamination solution between said decontamination tank and said oxidizing solution reservoir or said reducing solution reservoir.

A chemical decontamination apparatus for decontamination and cleaning up of an object placed in a decontamination tank is characterized by comprising: a first circulating path further comprising a decontamination tank, a circulating pump, and a heater for heating circulating water connected with a set of circulating pipes; an apparatus for adding an oxidizing agent into said first circulating path when said circulating water is heated by said heater and reaches at a pre-determined temperature; a transfer pump for transferring an oxidizing solution in said decontamination tank and said circulating pipes to an oxidizing solution reservoir subsequent to oxidizing decontamination; a second circulating path composed of adding a cation resin tower to said first circulating path; an apparatus for adding a reducing agent into said second circulating path when demineralized water is filled therein, circulated by said circulating pump, heated by said heater, and reaches at a pre-determined temperature; a reducing solution reservoir for storing said reducing solution in said decontamination tank and said circulating pipes by transferring with said transfer pump subsequent to said reducing decontamination; and a third circulating path composing a circulating cleaning up path by being added with a mixed bed resin tower to said first circulating path.

A chemical decontamination method for decontamination of an object placed in a decontamination tank is characterized by comprising the steps of: performing oxidizing decontamination of said decontamination object using an oxidizing solution filled in a first circulating path comprising said decontamination tank; transferring said oxidizing solution to an oxidizing solution reservoir subsequent to said oxidizing decontamination; performing reducing decontamination of said decontamination object using a reducing solution filled in a second circulating path comprising said decontamination tank; transferring said reducing solution to a reducing solution reservoir subsequent to said reducing decontamination; and cleaning up said decontamination object using water filled in a third circulating path comprising said decontamination tank.

A chemical decontamination apparatus for decontamination and cleaning up of an object placed in a decontamination tank is characterized by comprising: a first circulating path further comprising a decontamination tank, and a circulating pump; an oxidizing solution reservoir for storing an oxidizing solution in said first circulating path subsequent to oxidizing decontamination in said circulating path; a second circulating path comprising said decontamination tank, said circulating pump, and a cation resin tower; a reducing solution reservoir for storing a reducing solution in said second circulating path subsequent to reducing decontamination in said circulating path; and a third circulating path for cleaning up comprising said decontamination tank, said circulating pump, and a mixed bed resin tower.

A chemical decontamination apparatus is characterized by comprising: a decontamination tank for performing oxidizing decontamination and reducing decontamination; a set of circulating pipes for circulating decontamination solution in said decontamination tank; a chemical agent inlet for adding an oxidizing agent and a reducing agent into said circulating pipes; an oxidizing solution reservoir for storing said oxidizing solution used for oxidizing decontamination in said decontamination tank; and a reducing solution reservoir for storing said reducing solution used for reducing decontamination in said decontamination tank.

A decontamination apparatus is characterized by comprising a spray apparatus for spraying a decontamination solution or cleaning up water onto a decontamination object placed in a decontamination tank.

### BRIEF DESCRIPTION OF THE DRAWINGS

FIG. 1 is a drawing representing the configuration of one embodiment of a chemical decontamination apparatus according to the present invention;

FIG. 2 is a drawing representing the configuration of another embodiment according to the present invention;

FIG. 3 is a drawing representing the configuration of still another embodiment according to the present invention;

FIG. 4 is a drawing representing the configuration of still another embodiment of the present invention,

FIG. 5 is a drawing representing the configuration of a chemical decontamination apparatus according to the prior art; and

FIG. 6 is a drawing representing the configuration of another chemical decontamination apparatus having been employed conventionally.

### DETAILED DESCRIPTION OF THE INVENTION

(Description of the Preferred Embodiments)

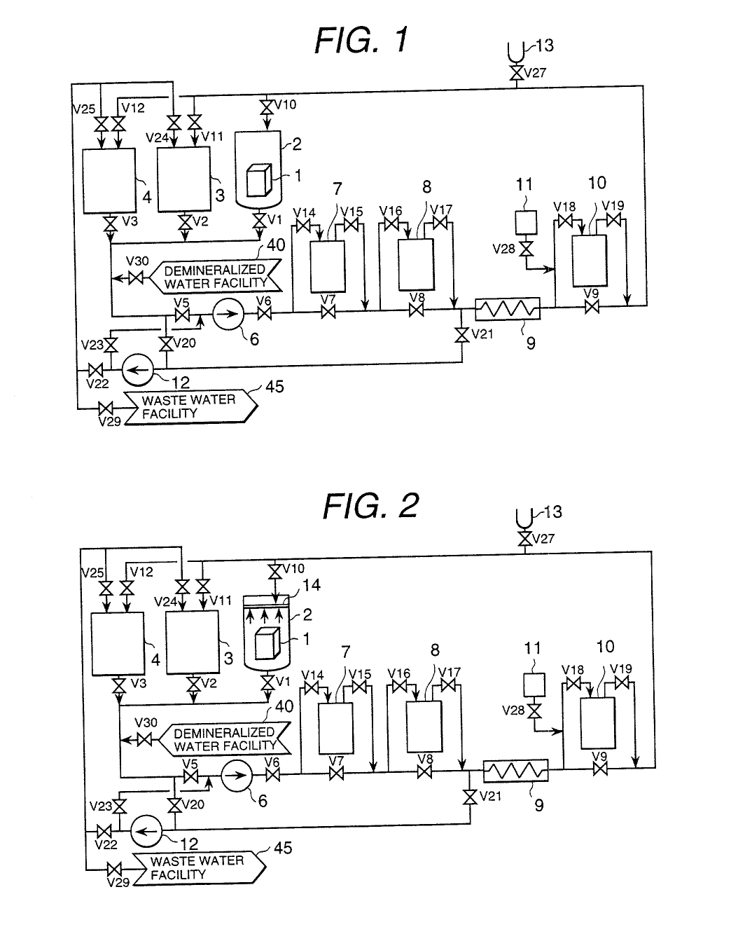

The preferred embodiments of the present invention will be described with reference to FIG. 1. FIG. 1 represents the configuration of one embodiment of a chemical decontamination apparatus according to the present invention. The chemical decontamination apparatus of this invention comprises a decontamination tank 2, a reducing solution reservoir 3, an oxidizing solution reservoir 4 and a circulating pipe. The circulating pipe is provided with a pump 6, a mixed bed resin tower 7, a cation resin tower 8, a heater 9, a reducing agent decomposer 10, a decomposing chemical injection apparatus 11 and chemical inlet 13. Further, a transfer pump 12 is installed on the pipe connecting among the circulating pipe, reducing solution reservoir 3 and oxidizing solution reservoir 4.

The object to be decontaminated 1 is normally subjected to several cycles of operation when oxidizing decontamination by oxidizing agent in a decontamination tank 2, reducing decontamination by reducing agent and cleaning are assumed to constitute one operation cycle. The repeated number of cycles may be one or several cycles, depending on the form of oxide film formed on the object to be decontaminated 1.

In the present embodiment the first cycle is carried out in the following order:

(1) An object to be decontaminated 1 is placed in a decontamination tank 2, and outlet/inlet valves V1 and V10 of the decontamination tank 2,

outlet/inlet valves V6 and V5 of a pump 6, bypass valves V7 and V8 of a mixed resin tower 7 and cation resin tower 8, and bypass valve V9 of the reducing agent decomposer 10 are opened. Then the valve V30 of a demineralizer 40 is opened, and the decontamination tank 2 and circulating pipe is filled with demineralized water.

(2) Then the pump 6 is started to perform circulating operation of demineralized water, and the temperature of demineralized water is heated by a heater 9.

(3) After the temperature has risen to a predetermined value, the valve V27 is opened, and oxidizing agent is supplied from the chemical inlet 13 of the chemical loader to turn it into oxidizing agent with a predetermined concentration of oxidizing agent. This reagent is used for oxidizing decontamination. This condition is kept unchanged for several hours to dissolve chromium oxide and others incorporated into the oxide film of the object to be decontaminated 1. In this case, the oxidizing decontamination can be performed efficiently by pre-determining an appropriate temperature of the demineralized water at adding an oxidizing agent to the demineralized water, an appropriate concentration of the oxidizing agent in the oxidizing solution for the oxidizing decontamination, and an appropriate time for the oxidizing decontamination. The temperature of the demineralized water, the concentration of the oxidizing solution, and the time for the oxidizing decontamination can be pre-determined so as to achieve a sufficient performance of the oxidizing decontamination. For instance, when potassium permanganate is used as the oxidizing agent, an appropriate temperature of the demineralized water at adding the oxidizing agent to the demineralized water is approximately 90° C., which makes the oxidizing agent readily soluble, the concentration of the decontamination agent in the decontamination solution is 200-300 ppm, and the time for the oxidizing decontamination is approximately 4-6 hours.

(4) Upon termination of oxidizing decontamination, inlet valves V20 and V21 and outlet valve V22 of the transfer pump 12, and the inlet valve V25 of oxidizing solution reservoir 4 and opened. The transfer pump 12 is started and oxidizing agent kept in the decontamination tank 2 and circulating pipe is transferred into the oxidizing solution reservoir 4 where it is stored. At the same time, the decontamination tank 2 and circulating pipe are made empty. Upon transfer of oxidizing agent, outlet/inlet valves V22, V20 and V21 of transfer pump 12 and inlet valve V25 of oxidizing solution reservoir 4 are closed.

(5) Before reducing decontamination is started, water in the chemical decontamination apparatus (decontamination tank and circulating path) is changed into reducing agent, similarly to the case of the aforementioned oxidizing decontamination. The outlet/inlet valves V1 and V10 of the decontamination tank 2, the outlet/inlet valves V6 and V5 of pump 6, the bypass valve V7 of mixed bed resin tower 7, the outlet/inlet valves V17 and V16 of cation resin tower 8 and the bypass valve V9 of reducing agent decomposer 10 are opened; then the valve V30 of demineralizer 40 is opened so that the decontamination tank 2 and circulating pipe are filled with demineralized water.

(6) Then the pump 6 is started to feed water to the cation resin tower 8. In the meantime, circulating operation is performed, and temperature is risen by the heater 9. The bypass valve V8 of the cation resin tower 8 is opened or adjust-opened so that the rate of water flow to the cation resin tower 8 is adjusted to a predetermined value.

(7) When temperature has risen to a predetermined value, the V27 is opened and reducing agent is supplied from the chemical inlet 13 so as to ensure a predetermined concentration of reducing agent. This condition is kept for about 10 hours, thereby dissolving iron oxide or the like as a major component of oxide film of the object to be decontaminated 1. At this time, reducing agent is supplied to the cation resin tower 8, so metal ion dissolved by reducing agent can be removed. In this case, the reducing decontamination can be performed efficiently by pre-determining an appropriate temperature of the demineralized water at adding the reducing agent to the demineralized water, an appropriate concentration of the reducing agent in the reducing solution for the reducing decontamination, and an appropriate time for the reducing decontamination. The temperature of the demineralized water, the concentration of the reducing solution, and the time for the reducing decontamination can be pre-determined so as to achieve a sufficient performance of the reducing decontamination. For instance, when oxalic acid is used as the reducing agent, an appropriate temperature of the demineralized water at adding the reducing agent to the demineralized water is approximately 90° C., which makes the reducing agent readily soluble, the concentration of the decontamination agent in the decontamination solution is 2000 ppm, and the time for the reducing decontamination is approximately 8-10 hours.

(8) Upon termination of reducing decontamination, the inlet valves V20 and V21 and outlet valve V22 of the transfer pump 12 and the inlet valve V24 of reducing solution reservoir 3 are opened. The transfer pump 12 is started, and reducing agent kept in the decontamination tank 2 and circulating pipe is transferred into reducing solution reservoir 3 where it is stored. At the same time, the decontamination tank 2 and circulating pipe are made empty. Upon transfer of reducing agent, the outlet/inlet valves V22, V20 and V21 of transfer pump 12 and the inlet valve V24 of reducing solution reservoir 3 are closed.

(9) Before the object to be decontaminated 1 is cleaned up, the outlet/inlet valves V1 and V10 of decontamination tank 2, the outlet/inlet valves V6 and V5 of pump 6, the inlet/outlet valves V15 and V14 of mixed bed resin tower 7, the bypass valve V8 of cation resin tower 8, and the bypass valve V9 of reducing agent decomposer 10 are opened; then valve V30 is opened so that the decontamination tank 2 and circulating pipe is filled with demineralized water.

(10) Then the pump 6 is started to feed water to the mixed bed resin tower 7. In the meantime, circulating operation is performed to clean up the object to be decontaminated 1, whereby deposited decontamination agent is removed by the mixed bed resin tower 7. The bypass valve V7 of the mixed bed resin tower 7 is closed or adjust-closed so that the rate of water flow to the mixed bed resin tower 7 is adjusted to a predetermined value. Upon termination of cleaning up of the object to be decontaminated 1, the outlet/inlet valves V22 and V21 of transfer pump 12 and the inlet valve V29 of drainage equipment 45 are opened so that water is drained from the outlet of mixed bed resin tower 7 to the drainage equipment.

In the present embodiment, a transfer pump 12 is used for drainage. The transfer pump 12 need not be used if drainage equipment and inlet valve 29 for drainage equipment are provided to permit drainage. In the present embodiment, the circulating path is composed by connecting the decontamination tank 2, the circulating pump 6, and the heater 9 with the circulating pipes. However, using a decontamination tank, wherein a heater is provided, the same advantages can be obtained by forming the circulating path by connecting the decontamination tank provided with the heater therein and a circulating pump with the circulating pipes. Furthermore, in accordance with the present embodiment, the circulating path is provided with a heater 9. However, if a sufficient decontamination performance is available without using the heater 9, the heater 9 may be eliminated from the circulating path.

The step of cleaning in oxidizing decontamination and reducing decontamination by the aforementioned method is assumed as the first cycle. In the second cycle, oxidizing agent and reducing agent used in the first cycle are employed to carry out decontamination. In oxidizing decontamination of the second cycle, oxidizing agent stored in oxidizing solution reservoir 4 is used to perform oxidizing decontamination. The second cycle is carried out in the following order:

(1) The outlet valve V3 of oxidizing solution reservoir 4, the outlet/inlet valves V23 and V20 of transfer pump 12, the outlet valve v6 of pump 6, the bypass valves V7 and V8 of hot bed resin tower 7 and cation resin tower 8, the bypass valve V9 of reducing agent decomposer 10 and the inlet valve V10 of decontamination tank 2 are opened to start the transfer pump 12, and oxidizing agent stored in the oxidizing solution reservoir 4 is transferred to the decontamination tank 2. This operation allows the decontamination tank 2 and circulating pipe to be filled with oxidizing agent.

(2) After that, the pump 6 is started to perform circulating operation, and oxidizing decontamination is carried out as in the first cycle. If temperature is reduced while oxidizing agent is stored in the oxidizing solution reservoir 4, it is raised by heater 9. Furthermore, if oxidizing agent concentration is reduced, valve V27 is opened to supply additional oxidizing agent through chemical inlet 13, whereby decontamination agent of a predetermined concentration is produced.

(3) Upon termination of oxidizing decontamination, oxidizing agent is fed from the decontamination tank 2 to the oxidizing solution reservoir 4 according to the same method as in the first cycle, and is stored therein. In the reducing decontamination of the second cycle, reducing agent stored in the reducing solution reservoir 3 is used to perform reducing decontamination.

(4) The outlet valve V2 of reducing solution reservoir 3, the outlet/inlet valves V23 and V20 of transfer pump 12, the outlet valve V6 of pump 6, the bypass valve V7 of mixed bed resin tower 7, the outlet/inlet valves V17 and V16 of cation resin tower 8, the bypass valve V9 of reducing agent decomposer 10, and the inlet valve V10 of decontamination tank 2 are opened to start the transfer pump 12, and reducing agent stored in the reducing solution reservoir 3 is fed to the decontamination tank 2. This operation allows the decontamination tank 2 and circulating pipe to be filled with reducing agent.

(5) After that, the pump 6 is started to send water to the cation resin tower 8, and circulating operation is made to carry out reducing decontamination in the same manner as in the first cycle. If temperature is reduced while reducing agent is stored in the reducing solution reservoir 3, it is raised by heater 9. Furthermore, if reducing agent concentration is reduced, valve V27 is opened to supply additional reducing agent through chemical inlet 13, whereby decontamination agent of a predetermined concentration is produced.

(6) Upon termination of reducing decontamination, reducing agent is fed from the decontamination tank 2 to the reducing solution reservoir 3 according to the same method as in the first cycle, and is stored therein. The object to be decontaminated 1 is cleaned up in the same manner as in the first cycle.

Oxidizing decontamination and reducing decontamination in the third cycle and thereafter are performed in the same manner as in the second cycle. Upon cleaning up of the object to be decontaminated 1, the object 1 is taken out of the decontamination tank 2. In this case, cleaning up water may be deposited on the surface of the object to be decontaminated 1, so it is preferred to remove water from the object 1 by blowing air or wiping the surface. When air is blown to the object to be decontaminated 1, it is preferred to install a spray nozzle for air blowing in the decontamination tank 2 and to blow air inside the decontamination tank 2 in order to prevent cleaning up water from being sent flying to unmanaged portions.

When there are multiple objects to be decontaminated, the second object and thereafter are decontaminated in the same method as that of the second cycle for the first object. Upon termination of a series of decontamination, decontamination agent is decomposed by mixing between oxidizing agent and reducing agent.

Namely, the outlet/inlet valves V2 and V11 of the reducing solution reservoir 3, the outlet/inlet valves V23 and V20 of transfer pump 12, the outlet valve V6 of pump 6, the bypass valves V7 and V8 mixed bed resin tower 7 and cation resin tower 8, and the bypass valve V9 of reducing agent decomposer 10 are opened to start the transfer pump 12. Reducing agent stored in the reducing solution reservoir 3 is supplied into the circulating pipe to start the pump 6 for circulating operation.

After that, the outlet/inlet valves V3 and V12 of oxidizing solution reservoir 4 are opened to absorb reducing agent and oxidizing agent simultaneously to mix reducing agent with oxidizing agent. Liquid mixture returns to the reducing solution reservoir 3 and oxidizing solution reservoir 4 through the heater 9. Decomposition of oxidizing agent can be promoted by raising temperature by heater 9. Oxidizing agent can be decomposed if mixing with reducing agent is possible. The aforementioned operation method need not always be used.

When oxidizing agent components have been decomposed, reducing agent component in liquid mixture is decomposed. Reducing agent decomposer 10 and decomposing chemical injection apparatus 11 are used to decompose reducing agent component in liquid mixture. Namely, the outlet/inlet valves V17 and V16 of cation resin tower 8 are opened, and the bypass valve V8 is closed or adjust-closed so that a predetermined flow rate of liquid is fed to the cation resin tower 8. Then the outlet valve V28 of decomposing chemical injection apparatus 11 is opened to pour decomposing chemicals. In the meantime, the outlet/inlet valves V19 and V18 of the reducing agent decomposer 10 are opened, and the bypass valve V9 is closed or adjust-closed so that a predetermined flow rate of liquid mixture is fed to the reducing agent decomposer 10. In this manner, liquid mixture is fed to the cation resin tower 8, whereby metal ion generated by decomposition of oxidizing agent can be absorbed and removed by cation resin. Furthermore, while decomposing chemical is poured, liquid is fed to the reducing agent decomposer 10, and this allows reducing agent component in liquid mixture to be decomposed.

When reducing agent component in liquid mixture has been decomposed to the level concentration below a predetermined value, the outlet valve V28 of the decomposing chemical injection apparatus 11 is closed, and the bypass valve V9 of the reducing agent decomposer 10 is opened. After that, the outlet/inlet valves V19 and V18 of reducing agent decomposer 10 are closed to terminate the decomposition of reducing agent.

After that, the outlet/inlet valves V15 and V14 of mixed bed resin tower 7 is opened, the bypass valve V7 is closed or adjust-closed, the bypass valve V8 of cation resin tower 8 is opened, and the outlet/inlet valves V17 and V16 are closed. Under this condition, a predetermined flow rate of liquid mixture is fed to the mixed bed resin tower 7. After it has been confirmed that quality of liquid mixture has reached the drainage reference, the outlet/inlet valves V22 and V21 of transfer pump 12 and the inlet valve V29 of the drainage equipment 45 are opened. Liquid is discharged to the drainage equipment from the outlet side of the mixed bed resin tower 7 using the transfer pump 12.

In the present embodiment, the transfer pump 12 is used for drainage. However, when a drain valve is provided to allow drainage by gravity, there is no need of using the transfer pump 12. In the present embodiment, the circulating path is composed by connecting the decontamination tank 2, the circulating pump 6, and the heater 9 with the circulating pipes. However, using a decontamination tank, wherein a heater is provided, the same advantages can be obtained by forming the circulating path by connecting the decontamination tank provided with the heater therein and a circulating pump 6 with the circulating pipes. Furthermore, in accordance with the present embodiment, the circulating path is provided with a heater 9. However, if a sufficient decontamination performance is available without using the heater 9, the heater 9 may be eliminated from the circulating path.

In the description of the aforementioned embodiment, the transfer pump 12 is used to transfer decontamination agent from inside chemical decontamination apparatus to the reducing solution reservoir 3 or oxidizing solution reservoir 4, or from reducing solution reservoir 3 or oxidizing solution reservoir 4 into the chemical decontamination apparatus. However, the transfer pump 12 need not always be used. For example, if the reducing solution reservoir 3 or oxidizing solution reservoir 4 is installed at a position lower than the chemical decontamination apparatus, decontamination agent can be transferred from inside the chemical decontamination apparatus to the reducing solution reservoir 3 or oxidizing solution reservoir 4 by gravity. Furthermore, decontamination agent can also be transferred from the reducing solution reservoir 3 or oxidizing solution reservoir 4 into the chemical decontamination apparatus by use of the pump 6 or application of gas pressure to the reservoir. To put it briefly, decontamination agent can be stored temporarily in the reducing solution reservoir 3 or oxidizing solution reservoir 4. It is essential only that decontamination agent can be transferred into the chemical decontamination apparatus whenever required.

In accordance with the present embodiment, the steps of oxidizing decontamination, reducing decontamination, and cleaning up are combined as a cycle, and decontamination and cleaning up are performed repeatedly. However, the steps of oxidizing decontamination and reducing decontamination can be combined as a cycle, and decontamination cycles may be performed repeatedly, and cleaning up may be performed when the cycle of decontamination is completed.

In accordance with the present embodiment, demineralized water is filled in the circulating path. However, water can be used instead of demineralized water.

As described above, decontamination agent is transferred from the decontamination tank 2 to reducing solution reservoir 3 or oxidizing solution reservoir 4, or from the reducing solution reservoir 3, or the oxidizing solution reservoir 4 to the decontamination tank 2. This eliminates the necessity of decomposing decontamination agent within the period of decontamination. When there are many objects to be decontaminated 1 and decontamination must be carried out repeatedly, decontamination agent can be used repeatedly. This signifies a substantial reduction in the amount of decontamination agent and resin to be used.

In the present embodiment, assume that there are four objects to be decontaminated, and an object 1 is decontaminated in the order of oxidizing decontamination, reducing decontamination and cleaning. Also assume that two hours are assigned for temperature increase, one hour for transfer of decontamination agent, one hour for re-increase of temperature, three hours for oxidizing decontamination, six hours for reducing decontamination, and six hours for cleaning. Table 2 shows an example of the chemical decontamination process when two cycles of operation are performed for one object to be decontaminated.

TABLE 2

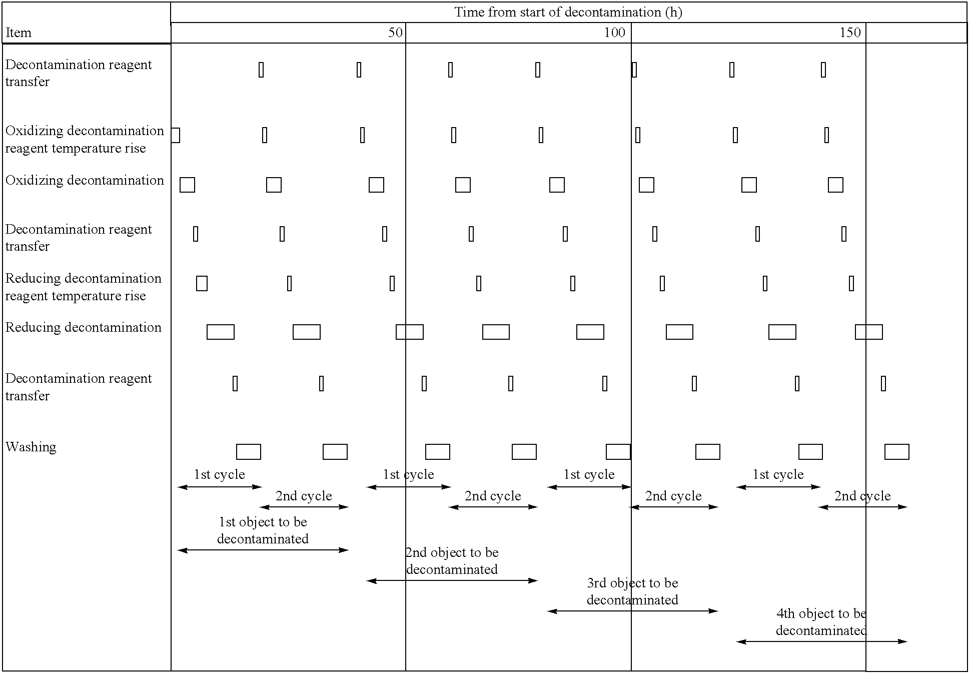

As shown in Table 2, about 40 hours are sufficient to decontaminate one object. Since decontamination of the second object and thereafter can be started upon decontamination of the preceding object to be decontaminated, one object can be decontaminated at intervals of about 40 hours. About 160 hours are sufficient for decontamination of four objects. In other words, decontamination is allowed in about 80% of the time required in the prior art method.

Further, objects can be decomposed without oxidizing agent and reducing agent being decomposed. This signifies a substantial reduction in the amount of chemicals used. For example, when the amount of oxidizing agent is 3 m³ and 200 ppm of potassium permanganate is used as oxidizing agent, about 0.6 kg of potassium permanganate will be required for each cycle.

When the amount of reducing agent is 3 m³ and 2000 ppm of oxalic acid is used as reducing agent, about 6 kg of oxalic acid will be required per cycle. Accordingly, when 10% chemicals are to be added in each cycle and one object is subjected to two cycles of decontamination, then decomposition of four objects requires only about 1.0 kg of potassium permanganate and about 10.2 kg of oxalic acid. In other words, the oxidizing agent required in the present embodiment is about 21% that required in the prior art, and the reducing agent required in the present embodiment is about 17% that required in the prior art. This means a substantial reduction in the amount of chemicals used. It should be noted that, the greater the number of cycles and the number of the objects to be decontaminated, the greater will be the effect of reducing the amount of chemicals used.

Since decomposition of oxidizing agent is not necessary during the period of decontamination, the metal ion generated by decomposition of oxidizing agent need not be decomposed or removed by cation resin. This can reduce the load of cation resin. For example, 200 ppm of potassium permanganate is used as an oxidizing agent, and 10% potassium permanganate is replenished in each cycle. Upon decomposition of four objects, the oxidizing agent is decomposed and the manganese ion and potassium ion resulting from decomposition are absorbed and removed by cation resin. If the surface area of one object to be decontaminated is 40 m², and the amount of oxidizing agent is 3 m³, then the amount of load of potassium ion and manganese ion generated by decomposition of oxidizing agent in the cation resin can be reduced to about 11% of the total load amount of cation resin. This is a substantial reduction in the load of resin as compared to the percentage of the prior art. It should be noted that, the greater the number of cycles and objects to be decontaminated, the greater will be the effect of reducing the resin load

FIG. 2 represents another embodiment according to the present invention. In this embodiment, a spray apparatus 14 is installed in the decontamination tank 2 so that decontamination agent or cleaning up water can be sprayed on the object to be decontaminated 1. In the present embodiment, the object to be decontaminated 1 need not be submerged by decontamination agent or cleaning up water, and decontamination can be carried out with a smaller amount of decontamination agent or cleaning up water. It is also possible to downsize the reducing solution reservoir 3 and oxidizing solution reservoir 4, and to decrease the decontamination agent decomposition time, the amount of decontamination agent to be used and the amount of cation resin load.

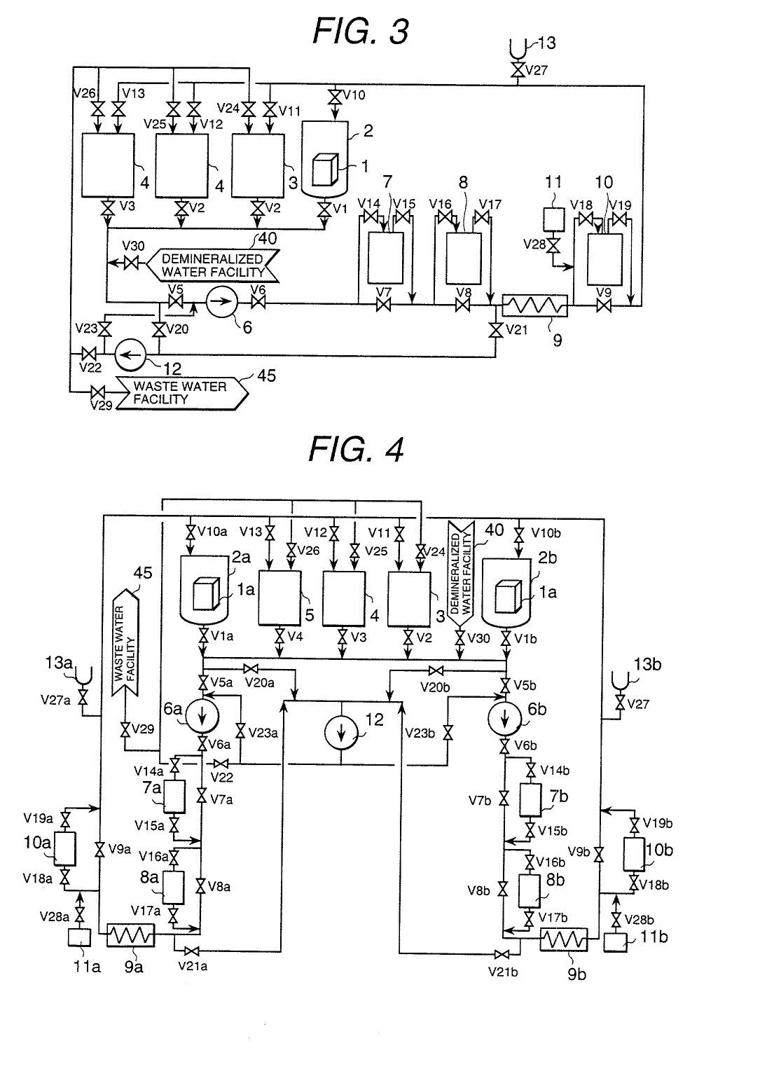

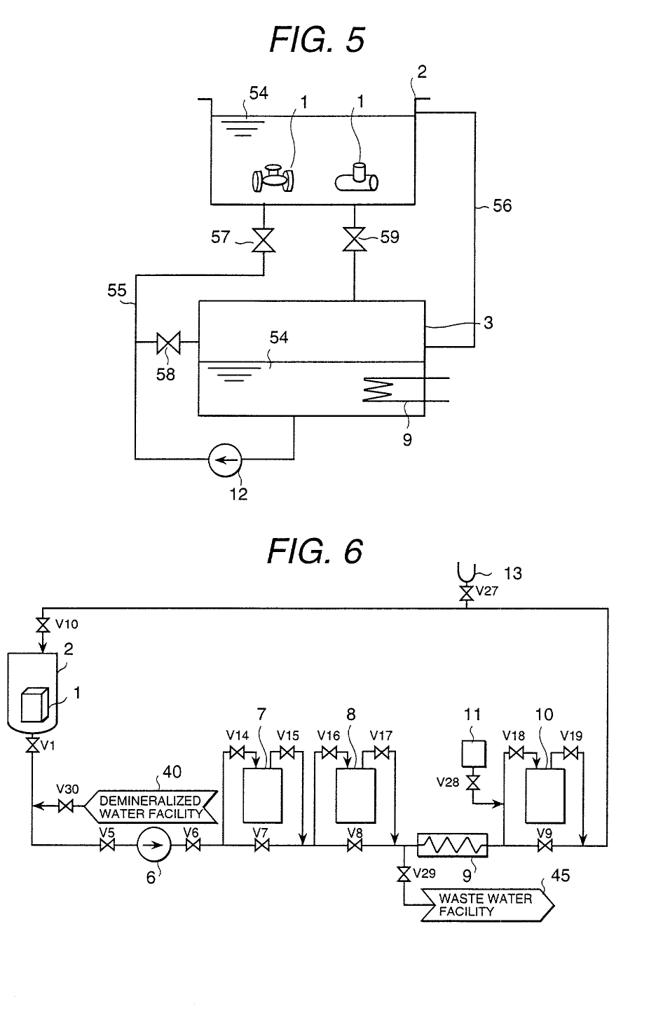

FIG. 3 represents still another embodiment according to the present invention. This embodiment is equivalent to the embodiment shown in FIG. 1 with a cleaning up water reservoir 5 added thereto. As described above, installation of a cleaning up water reservoir 5 reduces the amount of cleaning up water to be used.

Upon completion of cleaning up of the object to be decontaminated 1 in the first cycle, the inlet valves V20 and V21 and outlet valve V22 of the transfer pump 12 and the inlet valve v26 of cleaning up water reservoir 5 are opened. The transfer pump 12 is started and cleaning up water held in the decontamination tank 2 and circulating pipe transferred to the cleaning up water reservoir 5 where it is stored. At the same time, the decontamination tank 2 and circulating pipe are made empty. Upon transfer of cleaning up water, the outlet/inlet valves V22, V20 and V21 of transfer pump 12 and the inlet valve v26 of cleaning up water reservoir 5 are closed. After that, oxidizing decontamination of the second cycle is performed in the same manner as in embodiment 1.

When reducing decontamination in the second cycle is terminated and reducing agent is transferred to the reducing solution reservoir 3, the object to be decontaminated 1 is cleaned up. Before the object to be decontaminated 1 is cleaned up, cleaning up water stored in the cleaning up water reservoir 5 is transferred in the decontamination tank 2 and circulating pipe. In other words, the outlet valve V4 of cleaning up water reservoir 5, the outlet/inlet valves V23 and V20 of transfer pump 12, the outlet valve V6 of pump 6, the outlet/inlet valves V15 and V14 of mixed bed resin tower 7, the bypass V8 of cation resin tower 8, the bypass valve V9 of reducing agent decomposer 10 and the inlet valve V10 of decontamination tank 20 are opened. The transfer pump 12 is started and cleaning up water stored in the cleaning up water reservoir 5 is transferred to the decontamination tank 2. This operation allows the decontamination tank 2 and circulating pipe to be filled with oxidizing agent. After that, cleaning in the second cycle is carried out in the same manner as in FIG. 1.

FIG. 4 represents still another embodiment of the present invention. This embodiment shows the case wherein decontamination tanks 2 and circulating pipes thereof are provided for two systems; “a” and “b”. In this way, decontamination tanks and circulating pipes provided for two systems permit a further reduction of decontamination time (where valves of each system are shown with letters “a” and “b” added thereto).

Objects to be decontaminated 1a and 1b are installed in decontamination tanks 2a and 2b, respectively. The decontamination tank 2a and circulating pipe thereof are filled with oxidizing agent to carry out oxidizing decontamination. After oxidizing decontamination of the object to be decontaminated la, the transfer pump 12 is used to transfer oxidizing agent into the decontamination tank 2b and circulating pipe thereof. This allows the object to be decontaminated 1b to be subjected to oxidizing decontamination in the decontamination tank 2b. At the same time, the decontamination tank 2a and circulating pipe thereof are made empty. Then the decontamination tank 2a and circulating pipe thereof are filled with reducing agent to carry out reducing decontamination of the object to be decontaminated 1a.

After oxidizing decontamination of the object in the decontamination tank 2b, the transfer pump 12 is used to transfer oxidizing agent into the oxidizing solution reservoir 4, and decontamination tank 2b and circulating pipe thereof are made empty. After reducing decontamination of the object 1a in the decontamination tank 2a, the transfer pump 12 is used to transfer reducing agent into the decontamination tank 2b and circulating pipe thereof. This allows the object 1b to be subjected to reducing decontamination in decontamination tank 2b, and the decontamination tank 2a and circulating pipe thereof are made empty. Then the decontamination tank 2a and circulating pipe thereof is filled with cleaning up water so that the object to be decontaminated la can be cleaned up.

After reducing decontamination of the object 1b in the decontamination tank 2b, the transfer pump 12 is used to transfer reducing agent into the reducing solution reservoir 3 where it is stored. At the same time, the decontamination tank 2b and circulating pipe thereof are made empty. After cleaning up of the object to be decontaminated 1a in the decontamination tank 2a, the transfer pump 12 is used to transfer cleaning up water into the decontamination tank 2b and circulating pipe thereof. This allows the object 1b to be cleaned up in the decontamination tank 2b, and the decontamination tank 2a and circulating pipe thereof are made empty. Then the transfer pump 12 is used to ensure that oxidizing agent stored in the oxidizing solution reservoir 4 is transferred into the decontamination tank 2a and circulating pipe thereof; then oxidizing decontamination in the second cycle is carried out.

These operation steps allow decontamination to be carried out in two decontamination tanks using decontamination agent and cleaning up water for one system. Further, two objects are decontaminated at one period of time, and this contributes to more effective decontamination.

In the present invention, a reducing solution reservoir and oxidizing solution reservoir are installed, and decontamination agent is transferred from the decontamination tank into the reducing solution reservoir or oxidizing solution reservoir, and is then transferred from the reducing solution reservoir or oxidizing solution reservoir into decontamination tank. This permits repeated use of decontamination agent. Thus, the present invention provides decontamination characterized by shorter decontamination time, smaller amount of chemicals used, and reduced amount of resin load.

(Effects of the Invention)

According to the present invention, a reducing solution reservoir and oxidizing solution reservoir are installed, and decontamination agent is transferred from the decontamination tank into the reducing solution reservoir or oxidizing solution reservoir, and is then transferred from the reducing solution reservoir or oxidizing solution reservoir into decontamination tank. This permits repeated use of decontamination agent without decontamination agent being decomposed. Thus, the present invention provides decontamination characterized by shorter decontamination time, smaller amount of chemicals used, and reduced amount of resin load.

What is claimed is:

1. A chemical decontamination method for decontaminating of an object placed in a decontamination tank comprising the steps of:
forming a circulating path by connecting a decontamination tank, a heater and a circulating pump with a circulating pipe;
placing an oxidizing agent in said circulating path to carry out oxidizing decontamination;
transferring said oxidizing agent into an oxidizing solution reservoir subsequent to said oxidizing decontamination; and
if oxidizing decontamination is carried out thereafter, transferring decontamination agent into said decontamination tank from said oxidizing solution reservoir so as to circulate it in said circulating path whereby oxidizing decontamination is performed.

2. chemical decontamination method for decontamination of an object placed in a decontamination tank comprising the steps of:
forming a circulating path by connecting a decontamination tank, a heater and a circulating pump with a circulating pipe;
placing a reducing agent in said circulating path to carry out reducing decontamination;
transferring said reducing agent into a reducing solution reservoir subsequent to said reducing decontamination; and
if reducing decontamination is carried out thereafter, transferring decontamination agent into said decontamination tank from said reducing solution reservoir so as to circulate it in said circulating path, whereby reducing decontamination is performed.

3. chemical decontamination method for decontamination of an object placed in a decontamination tank comprising the steps of:
forming a first circulating path in such a way that a decontamination tank and a circulating pipe are filled with demineralized water, demineralized water is circulated by a circulating pump installed in the circulating pipe path, and the circulating water is heated by a heater installed in said circulating path;
forming a second circulating path in such a way that, when said circulating demineralized water has reached a predetermined temperature, oxidizing agent is placed in said path and is held at a predetermined concentration for a predetermined time to carry out oxidizing decontamination; then oxidizing agent in the decontamination tank and circulating pipe is transferred into an oxidizing solution reservoir by a transfer pump subsequent to oxidizing decontamination, and a cation resin tower is added over said first path;
forming a third path in such a way that;
said second circulating path is filled with demineralized water which is circulated by said circulating pump and heated by said heater;
when a predetermined temperature has reached, reducing agent put in said second path is held at a predetermined concentration of reducing agent for a predetermined time to carry out reducing decontamination,
then reducing agent in the reducing agent decontamination tank and circulating pipe is transferred to a reducing solution reservoir by a transfer pump subsequent to said reducing decontamination, and a mixed bed resin tower is added in said first path;
wherein, when demineralized water is filled to perform cleaning up by circulating and decontamination is carried out, said chemical decontamination method comprises the steps of:
transferring the decontamination agent of said oxidizing solution reservoir to said decontamination tank,
carrying out oxidizing decontamination in said manner,
transferring the decontamination agent of the reducing solution reservoir into said decontamination tank,
carrying out reducing decontamination in said manner, and
cleaning it in said third path, whereby the object is decontaminated repeatedly.

4. A chemical decontamination apparatus comprising a decontamination tank, a pump, a heater, a mixed bed resin tower, a cation resin tower, a reducing agent decomposer and decomposing chemical injection apparatus;
said chemical decontamination apparatus further characterized by comprising:
an oxidizing solution reservoir for storing the oxidizing agent decontamination agent used for decontamination in said decontamination tank,
a reducing solution reservoir for storing the reducing agent decontamination agent used for decontamination in said decontamination tank, and
a transfer pump for mutual transfer of decontamination agent located between said decontamination tank and oxidizing solution reservoir or reducing solution reservoir.

5. A chemical decontamination apparatus for decontamination of an object placed in a decontamination tank comprising:
a first circulating path further comprising a decontamination tank, a circulating pump and a heater for heating circulating water connected with one another by a circulating pipe;
a second circulating path further comprising an apparatus for placing oxidizing agent in said path when said circulating water is heated by said heater to reach a predetermined temperature, a transfer pump for transferring oxidizing agent in the decontamination tank and circulating pipe to the oxidizing solution reservoir subsequent to oxidizing decontamination, and a cation resin tower added over said first path; and
a third circulating path as a circulating and cleaning up path further comprising an apparatus for placing reducing agent in said path when said circulating water is heated by said heater to reach a predetermined temperature, a reducing solution reservoir for storing reducing agent of the decontamination tank and circulating pipe having been transferred by said transfer pump subsequent to reducing decontamination, and a mixed bed resin tower added over said first path, whereby decontamination and cleaning up are performed.

6. A decontamination apparatus wherein a spray apparatus for sprinkling decontamination agent or cleaning up water over an object to be decontaminated is installed inside the decontamination tank according to claim 5.

7. A chemical decontamination method for decontamination of an object placed in a decontamination tank comprising the steps of:
decontaminating said object by oxidizing decontamination using an oxidizing solution filled in a first circulating path including said decontamination tank,
transferring said oxidizing solution to an oxidizing solution reservoir after completion of said oxidizing decontamination
decontaminating said object by reducing decontamination using a reducing solution filled in a second circulating path including said decontamination tank,
transferring said reducing solution to a reducing solution reservoir after completion of said reducing decontamination, and
cleaning up said object using cleaning up water filled in a third circulating path including said decontamination tank.

8. A chemical decontamination method as claimed in claim 7, wherein
said first circulating path includes a circulating pump,
said second circulating path includes a circulating pump and a cation resin tower, and
said third circulating path includes a circulating pump and a mixed bed resin tower.

9. A chemical decontamination method as claimed in claim 8, wherein
said first circulating path includes a heater, and
said second circulating path includes a heater and a reducing agent decomposer.

10. A chemical decontamination method as claimed in claim 8, wherein
said heater is installed in said decontamination tank.

11. A chemical decontamination method as claimed in any one of claims 7 to 10, wherein
the steps of:
exhausting said cleaning up water in said third circulating path after said cleaning up operation;
transferring said oxidizing solution in said oxidizing solution reservoir to said first circulating path, and performing said oxidizing decontamination and transfer of said oxidizing solution;
transferring said reducing solution in said reducing solution reservoir to said second circulating path, and performing said reducing decontamination and transfer of said reducing solution; and
performing said cleaning up operation;
are performed repeatedly at least once.

12. A chemical decontamination method as claimed in any one of claims 7 to 10, wherein
the steps of:
transferring said cleaning up water to a cleaning up water reservoir after said cleaning up operation;
transferring said oxidizing solution in said oxidizing solution reservoir to said first circulating path, and performing said oxidizing decontamination and transfer of said oxidizing solution;
transferring said reducing solution in said reducing solution reservoir to said second circulating path, and performing said reducing decontamination and transfer of said reducing solution; and
transferring said cleaning up water in said cleaning up water reservoir to said third circulating path, and performing said cleaning up operation;
are performed repeatedly at least once.

13. A chemical decontamination method as claimed in any one of claims 7 to 10, wherein,
subsequent to transferring said reducing solution and prior to said cleaning up operation,
the steps of:
transferring said oxidizing solution in said oxidizing solution reservoir to said first circulating path, and performing said oxidizing decontamination and transfer of said oxidizing solution; and
transferring said reducing solution in said reducing solution reservoir to said second circulating path, and performing said reducing decontamination and transfer of said reducing solution;
are performed repeatedly at least once.

14. A chemical decontamination apparatus for decontamination of an object placed in a decontamination tank comprising:
a first circulating path further comprising said decontamination tank, and a circulating pump;
an oxidizing solution reservoir for storing oxidizing solution in said first circulating path after oxidizing decontamination by said circulating path;
a second circulating path further comprising said decontamination tank, said circulating pump, and a cation resin tower;
a reducing solution reservoir for storing reducing solution in said second circulating path after reducing decontamination by said circulating path; and
a third circulating path for cleaning up further comprising said decontamination tank, said circulating pump, and a mixed bed resin tower.

15. A chemical decontamination apparatus as claimed in claim 14, wherein
said circulating path includes a heater, and
said second circulating path includes a heater and a reducing agent decomposer.

16. A chemical decontamination apparatus comprising:
a decontamination tank for performing oxidizing decontamination and reducing decontamination of decontamination objects,
a set of circulating pipes for circulating decontamination solution in said decontamination tank,
a chemical agent inlet for adding an oxidizing agent and a reducing agent into said set of circulating pipes,
an oxidizing solution reservoir for storing oxidizing solution used for oxidizing decontamination in said decontamination tank, and
a reducing solution reservoir for storing reducing solution used for reducing decontamination in said decontamination tank.
